(19) United States
(12) Patent Application Publication
(10) Pub. No.: US 2002/0197088 A1
(43) Pub. Date: Dec. 26, 2002

(54) Printer arranged with at least one custom toner module

(75) Inventor: Michael D. Thompson, Rochester, NY (US)

Correspondence Address: Patent Documentation Center, Xerox Corporation, Xerox Square 20th Floor, 100 Clinton Ave.S., Rochester, NY, 14644, US

(73) Assignee: Xerox Corporation

(21) Appl. No.: 09/886,770

(22) Filed: Jun. 21, 2001

(51) Int. Cl. G03G 15/01

(52) U.S. Cl. 399/302

(57) ABSTRACT

A xerographic printer includes a custom toner module. The custom toner module is arranged to form a developed custom toner image and thereafter to transfer this developed custom toner image onto an existing developed image. In a monochrome printer embodiment, the custom toner module transfers the developed custom toner image onto an existing developed monochrome image. In a multi-color printer embodiment, the custom toner module transfers the developed custom toner image onto an existing developed multi-toner image.

### FIELD OF THE INVENTION

This invention pertains to xerography and more particularly to a xerographic printer arranged with at least one custom toner module.

### BACKGROUND OF THE INVENTION

In the printing industry, custom colors are typically printed with a separately-blended ink applied in a separate station as another color separation. Liquid inks used in the printing industry mix well and stay homogeneous and generally produce stable, precise custom colors.

Custom color is used in the printing industry to satisfy customer requirements for unique color to uniquely identify their product or service. Highlight color is used to highlight various features in a document and is intended to draw the eye of the viewer to particular elements of a document or to help distinguish various aspects of a document to improve readability. Highlight or custom colors are laid down as single toner colors or blends of special primary sets which have been shown to produce custom and “pantone” (trade mark) color sets. The advantages of producing custom colors in this way instead of using a CYMK full process color approach have been mentioned elsewhere but will be mentioned here briefly. These advantages include, larger range of gamut, smooth, higher resolution fonts, as well as high-resolution custom color lines.

Dry powder custom color printing represents an opportunity for xerography in that it would allow all the advantages of electronic printing to play in a market now limited to conventional plate print engines. Dry powder highlight color printing has been practiced by Xerox in the 4890 family, for example, but only with a very limited number of colors and at fairly low print quality levels. This limited highlight color set is a result of architectural and toner compatibility difficulties, that is, custom colors formed from blends of primaries will not remain homogeneous and powder development systems tend to scavenge previously-developed images. The 4890, for example, requires a complex xerographic design, that is, tri-level xerography, and complex development subsystem architecture to insure that the development systems don't interact with the previous images to produce cross-contamination and color hue shifts. The result of this approach is a system limited both in color gamut and print quality in a very restricted architecture.

Xerox has been successful with highlight color in the past with the 4890 family of highlight color printers. The approach Xerox has used in these printers is a proprietary process known as “tri-level” xerography, coupled with special colored toners or mixtures of toners for producing the highlight colors. This approach has the advantage of perfect registration since the laser writes the highlight and black image together. One disadvantage here is the development system is burdened with the task of not disturbing the previously-developed image while developing the color image with a low development potential. Disturbances lead to degradation of the developed image as well as cross-contamination of the developer, causing shifts in color hue over long times which are unacceptable to a customer printing a custom color. Another disadvantage is the high contrast voltages and tight restrictions on the charging and exposure systems. The tri-level development system must split the contrast between the two colors requiring very large development housings to enable development with low development fields which stresses development. Another disadvantage here is the highlight color machine architecture is very specific to custom color. The machine must be designed almost from the beginning for highlight color, making it difficult to insert a highlight color capability into existing architectures. Charging, imaging, development and the control system must be interwoven into any previously designed system.

### SUMMARY OF THE INVENTION

In one embodiment, a printer comprises a monochrome developer module arranged to form a developed monochrome image on a photoreceptor, and at least one custom toner module arranged to form a developed custom toner image and thereafter to transfer this developed custom toner image onto the developed monochrome image, thus forming a finished composite image.

In a further embodiment, a printer comprises a plurality of developer modules arranged to form and transfer a developed multi-color image to an intermediate transfer member, and at least one custom toner module arranged to form a developed custom toner image and thereafter to transfer this developed custom toner image onto the developed multi-color image, thus forming a finished composite image.

### BRIEF DESCRIPTION OF THE DRAWING

FIG. 1 depicts a xerographic monochrome printer 100 arranged with at least one custom toner module 150;

FIG. 2 depicts a xerographic multi-color printer 200 arranged with at least one custom toner module 250; and

FIG. 3 depicts a custom toner source 300 which may be used with either the FIG. 1 custom toner module 150 or the FIG. 2 custom toner module 250.

### DETAILED DESCRIPTION OF THE INVENTION

Briefly, a xerographic printer includes at least one custom toner module arranged to form a developed custom toner image and thereafter to transfer this developed custom toner image onto an existing developed image. In a monochrome printer embodiment, the at least one custom toner module transfers the developed custom toner image onto an existing developed monochrome image. In a multi-color printer embodiment, the at least one custom toner module transfers the developed custom toner image onto an existing developed multi-toner image.

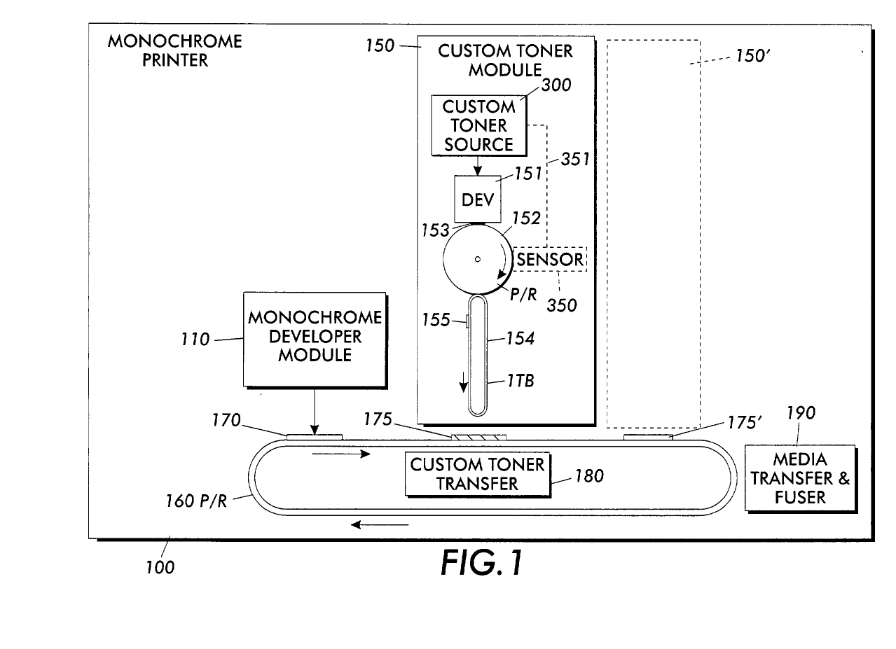

Referring now to FIG. 1 there is shown a xerographic monochrome printer 100 arranged with at least one custom toner module 150. As shown, the printer 100 comprises a monochrome developer module 110. In turn, the monochrome developer module 110 is arranged to form a developed monochrome image 170 on a moving photoreceptor 160.

It will be understood that the monochrome developer module 110 comprises any convenient xerographic developing means.

In one embodiment, for example, the monochrome developer module 110 comprises a conventional black-and-white toner developer module, with the corresponding monochrome image 170 comprising a typical black-and-white image.

Still referring to FIG. 1, the printer 100 also includes at least one custom toner module 150. As shown, the custom toner module 150 comprises a custom toner source 300 arranged to supply a custom toner comprising dry powder to a custom toner developer unit 151. In turn, the custom toner developer unit 151 is arranged to form a developed custom toner image 153 on a photoreceptor 152.

In one embodiment, the custom toner developer unit 151 comprises a magnetic brush SCMB developing system.

In one embodiment, depicted in broken lines in FIG. 1, the custom toner module 150 optionally includes custom toner sensing means 350 arranged for sensing the developed custom toner image 153 on the photoreceptor 152. In one embodiment, for example, the custom toner sensing means 350 comprises an inline spectrophotometer arranged for forming an output signal 351 that is based on the spectral or color content of the developed custom toner image 153.

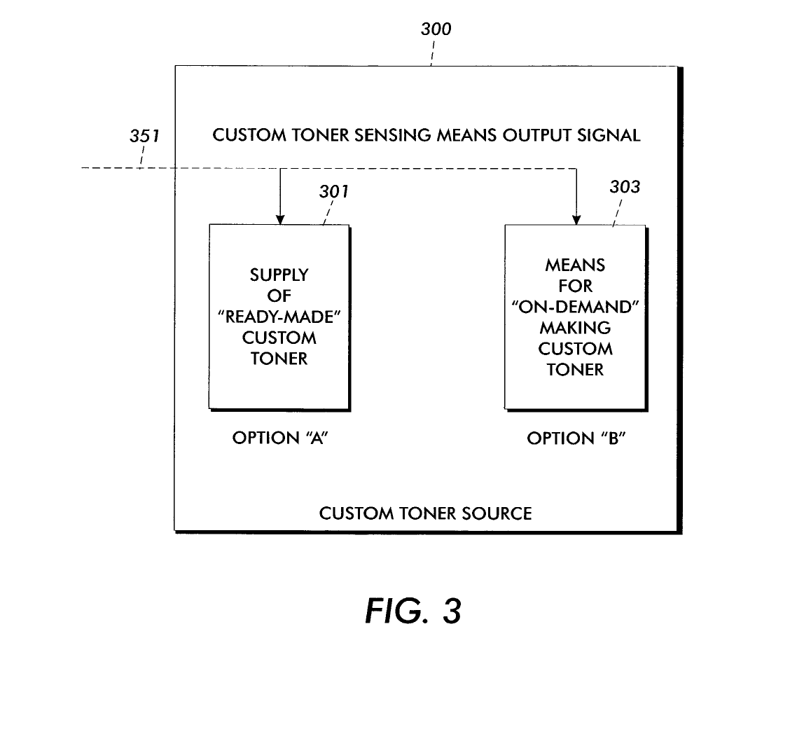

The custom toner source 300 is shown in greater detail in FIG. 3, which is described below.

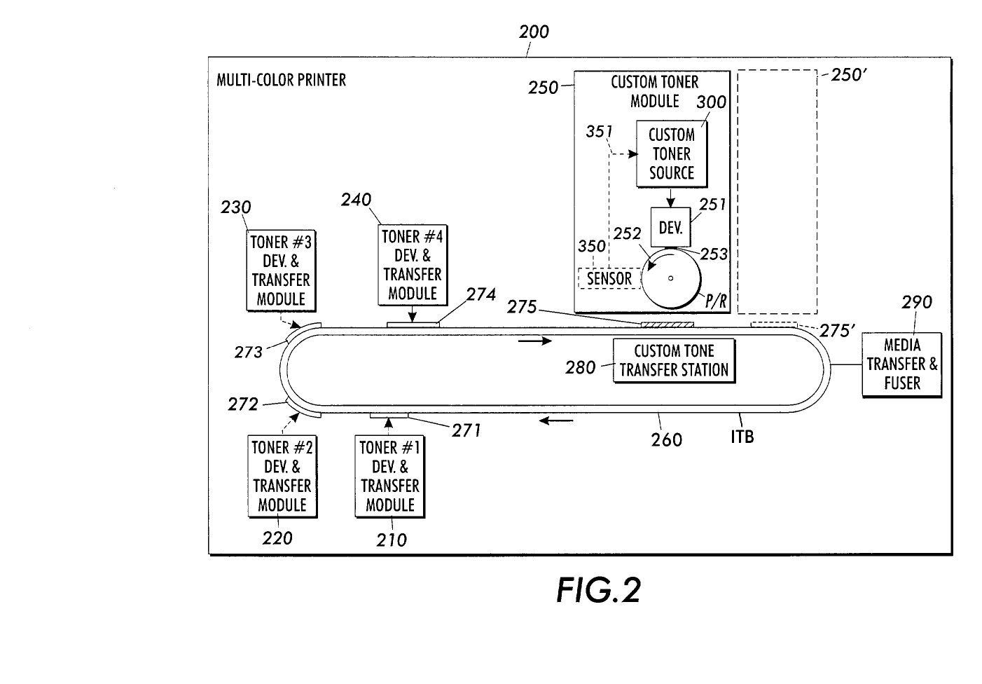

Referring now to FIG. 3, there is depicted a custom toner source 300. As discussed in greater detail below, the custom toner source 300 may be used with the custom toner module 150 of FIG. 1, the custom toner module 250 of FIG. 2, or both.

As shown in FIG. 3, there are at least two embodiments of the custom toner source 300. In a first embodiment of the custom toner source 300, labeled “option A” in FIG. 3, the custom toner source 300 comprises a supply 301 of “ready made” custom dry powder toner. In a variation of this first embodiment, depicted in broken lines, the custom toner supply 301 is optionally arranged to be controlled by or responsive to the custom toner sensing means 350's output signal 351.

In a second embodiment of the custom toner source 300, labeled “option B” in FIG. 3, the custom toner source 300 comprises means 303 for “on-demand” making the custom toner. In this second embodiment, the “on-demand” custom toner making means 303 is arranged to blend and deliver to the custom toner developer unit (corresponding to element 151 in FIG. 1 and element 251 in FIG. 2) a precise mixture of custom color toner primaries, the primary set being appropriately chosen for the custom color being used.

In a variation of this second embodiment, depicted in broken lines, the “on-demand” custom toner making means 303 is optionally arranged to be controlled by or responsive to the custom toner sensing means output signal 351, thus enabling the system to blend and deliver consistent custom toner color. In this variation it will be understood that the “on-demand” custom toner making means 303 may include, for example, a control loop for controlling the custom color toner primary mixing and delivering process based on the custom toner sensing means output signal 351.

Returning now to FIG. 1, the photoreceptor 152, in turn, is arranged to thereafter transfer the developed custom toner image 153 onto an intermediate transfer member 154, the transferred image being depicted in FIG. 1 as element 155.

In one embodiment, the intermediate transfer member 154 comprises a belt. In a further embodiment, the intermediate transfer member 154 comprises a drum.

It will be understood that such image transfer from the photoreceptor 152 to the intermediate transfer member 154 may be accomplished by any convenient xerographic transfer means such as, for example, bias transfer rollers (“BTR”).

It will be understood that, subsequent to image transfer to the intermediate transfer member 154, the photoreceptor 152 is cleaned prior to the next development cycle. This photoreceptor 152 cleaning step is not depicted in FIG. 1.

Still referring to FIG. 1, after the developed custom toner image 155 is transferred to the intermediate transfer member 154, the intermediate transfer member 154 is arranged to act in concert with a custom toner transfer station 180 to again transfer the developed custom toner image 155 onto the developed monochrome image 170 resident on the moving photoreceptor 160, thus forming a finished composite image 175 on the moving photoreceptor 160.

It will be understood that the custom toner transfer station 180 may comprise any convenient xerographic transfer means such as, for example, bias transfer rollers.

It will be understood that, subsequent to image transfer to the moving photoreceptor 160, the intermediate transfer member 154 is cleaned. This intermediate transfer member 154 cleaning step is not depicted in FIG. 1.

Subsequent to the finished composite image 175 being formed by the custom toner module 150, the printer 100 includes further means 190 for transferring and fusing the finished composite image 175 onto a suitable media. In one embodiment, for example, the media comprises paper.

Still referring to FIG. 1, it will be understood that the monochrome printer 100 may include more than one custom toner modules 150.

For example, the printer 100 may include two custom toner modules. In this embodiment the first custom toner module comprises the above-described module 150 and the second custom toner module being depicted in FIG. 1 as element 150′. As will be understood, in this embodiment the second custom toner module 150′ will be arranged to form a second developed toner image and thereafter to transfer this second custom toner image onto the existing composite image 175, thereby forming a finished composite image 175′.

By further application of the above principle, it will be understood that the printer 100 may include an arbitrary number of custom toner modules 150.

Referring now to FIG. 2, there is shown a xerographic multi-color printer 200 arranged with at least one custom toner module 250. As shown, the printer 200 comprises a plurality of developer modules 210, 220, 230, 240, each developer module of the plurality of developer modules 210, 220, 230, 240 arranged to form and transfer a different color image 271, 272, 273, 274 to a moving intermediate transfer member 260. As a result, a developed multi-color image 274 is transferred to the intermediate transfer member 260.

In one embodiment, the intermediate transfer member 260 comprises a belt. In a further embodiment, the intermediate transfer member 260 comprises a drum.

While four (4) developer modules 210, 220, 230 and 240 are depicted in FIG. 2, it will be understood that the multi-color xerographic printer 200 may comprise an arbitrary number of developer modules.

Still referring to FIG. 2, it further will be understood that each developer module of the plurality of developer modules 210, 220, 230 and 240 may comprise any convenient xerographic developing means.

In one embodiment, for example, the plurality of developer modules 210, 220, 230 and 240 depicted in FIG. 2 comprise the well-known conventional four-color xerographic arrangement of Cyan, Yellow, Magenta, and Black developer modules.

In another embodiment, for example, the plurality of developer modules comprises only three (3) developer modules.

It will be understood that, in general, the printer 200 may comprise an arbitrary number of developer modules, such as 2, 3, 4, etc.

Still referring to FIG. 2, the printer 200 also includes at least one custom toner module 250. As shown, the custom toner module 250 comprises a custom toner source 300 arranged to supply a custom toner comprising dry power to a custom toner developer unit 251. In turn, the custom toner developer unit 251 is arranged to form a developed custom toner image 253 on a photoreceptor 252.

In one embodiment, the custom toner developer unit 251 comprises a magnetic brush SCMB developing system.

In one embodiment, depicted in broken lines in FIG. 2, the custom toner module 250 optionally includes the custom toner sensing means 350 discussed in connection with FIG. 1 above which is arranged for sensing the developed custom toner image 253 on the photoreceptor 252. Similar to the discussion of the custom toner sensing means 350 in FIG. 1 above, in one embodiment, for example, the custom toner sensing means 350 comprises an inline spectrophotometer arranged for forming the output signal 351 that is based on the spectral or color content of the developed custom toner image 253.

The custom toner source 300 is identical to that discussed above in connection with FIG. 3.

Still referring to FIG. 2, the photoreceptor 252, in turn, is arranged to act in concert with a custom toner transfer station 280 to transfer the developed custom toner image 253 onto the developed multi-color image resident on the moving intermediate transfer member 260, thus forming a finished composite image 275 on the moving intermediate transfer member 260.

It will be understood that the custom toner transfer station 280 may comprise any convenient xerographic transfer means such as, for example, bias transfer rollers.

It will be understood that, subsequent to the image transfer to the moving image transfer member 260, the photoreceptor 252 is cleaned prior to the next development cycle. This photoreceptor 252 cleaning step is not depicted in FIG. 2.

Subsequent to the finished composite image 275 being formed by the custom toner module 250, the printer 200 includes further means 290 for transferring and fusing the finished composite image 275 onto a suitable media. In one embodiment, for example, the media comprises paper.

Still referring to FIG. 2, it will be understood that the multi-color printer 200 may include more than one custom toner modules 250.

For example, the printer 200 may include two custom toner modules. In this embodiment the first custom toner module comprises the above-described module 250 and the second custom toner module being depicted in FIG. 2 as element 250′. As will be understood, in this embodiment the second custom toner module 250′ will be arranged to form a second developed toner image and thereafter to transfer this second custom toner image onto the existing composite image 275, thereby forming a finished composite image 275′.

By further application of the above principle, it will be understood that the printer 200 may include an arbitrary number of custom toner modules 250.

Thus there is disclosed herein a dry power xerographic module for custom color applications. The elements include a development system which delivers a blended mixture of custom color toner primaries to a photoreceptor, and thereafter to the main photoreceptor 160 of FIG. 1, or to the main intermediate transfer member 260 of FIG. 2, and ultimately transferred to a media. In one embodiment, the custom toner is blended external to the printer. In another embodiment, the custom toner is blended inside the printer's custom toner module, using a spectrophotometer and control loop in the mixing and dispense system to deliver consistent color. Registration issues are solved similar to tandem xerographic engines. A very important advantage to this approach is that it allows the possibility for custom color to be inserted into an existing monochrome or black and white printer.

Moreover, there is disclosed an approach to custom color using a self-contained module in the spirit of a primary color module in a tandem engine full process color IOT. The highlight or custom color is created from a single special toner (option “A”, element 301) or as a blend of custom color primaries (option “B”, element 303) which address toner compatibility issues, as shown in FIG. 3.

The custom color latent image is created in the module in the normal xerographic way by charging a photoreceptor and developing at the custom color develop unit (element 151 in FIG. 1 or element 251 in FIG. 2). There is an inline spectrophotometer (element 350 in FIGS. 1 and 2) looking at the toner color on the custom color photoreceptor. In the custom toner blending option “B”, if the color wanders, it can be adjusted by dispensing the appropriate amount of custom color primary toner or, in the case of a highlight color toner, through adjustment of the development bias, toner concentration, or both.

This approach includes the following advantages: First, by allowing the possibility for adding custom color to an existing B&W architecture. Second, toner can be designed with the same charge, unlike the situation in tri-level xerography leveraging knowledge gained from a single material. Third, toner-toner interactions happen in the transfer step at the intermediate member interface, which is much easier to deal with successfully than in the development nip. Fourth, the control scheme allows precise color control; the system does not need to be perfect with respect to zero differential development for toner blends. Fifth, the intermediate member protects the custom color development system from contamination; if there is back transfer from the main image, it will be cleaned off before it sees the custom color development zone.

Moreover, this approach should relax materials constraints and allow a broader range of custom colors.

While various embodiments of a printer arranged with at least one custom toner module have been described above, the scope of the invention is defined by the following claims.

What is claimed is:

1. A printer comprising:
a monochrome developer module arranged to form a developed monochrome image on a photoreceptor, and
at least one custom toner module arranged to form a developed custom toner image and thereafter to transfer this developed custom toner image onto the developed monochrome image, thus forming a finished composite image.

2. The printer of claim 1, the monochrome image comprising a black-and-white image.

3. The printer of claim 1, including means for transferring and fusing the finished composite image onto a media.

4. The printer of claim 1, the at least one custom toner module comprising a custom toner developer unit arranged with a photoreceptor for forming the developed custom toner image, the photoreceptor arranged with an intermediate transfer member element and a custom toner transfer station for transferring the developed custom toner image onto the developed monochrome image.

5. The printer of claim 4, the custom toner developer unit comprising a magnetic brush developing system.

6. The printer of claim 4, wherein the at least one custom toner module includes a custom toner source.

7. The printer of claim 6, the custom toner comprising a dry powder.

8. The printer of claim 6, wherein the custom toner source comprises a “ready-made” supply of the custom toner.

9. The printer of claim 6, including custom toner sensing means for sensing the developed custom toner image.

10. The printer of claim 9, wherein the custom toner source comprises means for “on-demand” making the custom toner responsive to the custom toner sensing means.

11. A printer comprising:
a plurality of developer modules arranged to form and transfer a developed multi-color image to an intermediate transfer member, and
at least one custom toner module arranged to form a developed custom toner image and thereafter to transfer this developed custom toner image onto the developed multi-color image, thus forming a finished composite image.

12. The printer of claim 11, the plurality of developer modules comprising at least three developer modules.

13. The printer of claim 11, including means for transferring and fusing the finished composite image onto a media.

14. The printer of claim 11, the at least one custom toner module comprising a custom toner developer unit arranged with a photoreceptor for forming the developed custom toner image, the photoreceptor further arranged with a custom toner transfer station for transferring the developed custom toner image onto the developed multi-color image.

15. The printer of claim 14, the custom toner developer unit comprising a magnetic brush developing system.

16. The printer of claim 14, wherein the at least one custom toner module includes a custom toner source.

17. The printer of claim 16, the custom toner comprising a dry powder.

18. The printer of claim 16, wherein the custom toner source comprises a “ready-made” supply of the custom toner.

19. The printer of claim 16, including custom toner sensing means for sensing the developed custom toner image.

20. The printer of claim 19, wherein the custom toner source comprises means for “on-demand” making the custom toner responsive to the custom toner sensing means.
